(19) United States
(12) Patent Application Publication
(10) Pub. No.: US 2004/0099337 A1
(43) Pub. Date: May 27, 2004

(54) A Method and a system for loading and storage of oil from a production platform on a dynamically positioned tanker

(75) Inventors: Tor Erik Hilden, Stavanger (NO); Trygve Gerhard Egge, Hafrsfjord (NO); Narve Oma, Royneberg (NO); Kjell Egil Helgoy, Bru (NO)

Correspondence Address: JENKENS & GILCHRIST, PC, 1445 ROSS AVENUE, SUITE 3200, DALLAS, TX, 75202, US

(73) Assignee: Navion ASA

(21) Appl. No.: 10/425,390

(22) Filed: Apr. 29, 2003

(30) Foreign Application Priority Data
Nov. 22, 2002 (NO) 2002 5620

(51) Int. Cl. B67C 3/00

(52) U.S. Cl. 141/387; 137/615

(57) ABSTRACT

A method and a system for loading and storage of oil from a production platform on a tanker (FSO vessel) which is equipped with a dynamic positioning system (DP system), the oil being transferred via a loading hose extending between the platform and the tanker. The tanker when required is moved substantially along a circular arc which is predefined in relation to the platform, at the same time as the tanker by means of the DP system when required is turned about a defined point on the tanker, for achieving an optimum power consumption during the loading operation.

The invention relates to a method and a system for loading and storage of oil from a production platform on a tanker having a DP system for dynamic positioning, wherein the oil is transferred via a loading hose extending between the tanker and the platform.

In connection with offshore oil extraction from oilfields in deep waters it is usually necessary, when developing such fields, that these are connected to pipeline systems for transporting the oil to land terminals. Such pipeline systems in many cases will be very expensive, and may to a substantial degree contribute to the development costs. Nor is the technology developed for large water depths.

The object of the present invention is to provide a method and a system enabling the development of deep-sea fields without these being connected to pipeline systems.

Another object of the invention is to use dynamically positioned tankers (FSO tankers) as storage tankers for oil.

According to the invention, the above-mentioned objects are achieved with a method of the introductorily stated type wherein the tanker, when required, is moved substantially along a circular arc which is predefined relatively to the platform, at the same time as the tanker by means of the DP system when required is turned about a defined point on the tanker, for achieving an optimum power consumption during the loading operation.

According to the invention there is also provided a system for loading and storage of oil from a production platform on a tanker which is provided with a dynamic positioning system (DP system), the oil being transferred via a loading hose extending between the platform and the tanker, and wherein the propulsion system and the DP system of the tanker are arranged to be controlled such that the tanker when required is moved substantially along a circular arc which is predefined relatively to the platform, and such that the tanker when required is also turned about a defined point on the tanker, for achieving an optimum power consumption during the loading operation.

In the method according to the invention a dynamically positioned tanker is used as a storage tanker for the crude oil from a production platform. The method also comprises the use of shuttle tankers for transport of the crude oil from the field to terminals ashore. The storage tanker will maintain the position by means of a main propeller and thrusters, and will all the time be located such that, in case of a possible fault in the positioning system (“drive off” or “drift off”), it will not hit the production platform. The storage tanker will be equipped with a DP installation having redundant systems according to IMO DP class II. This implies that the propulsion systems of the tanker, electrical systems and other vital equipment for the operation of the tanker are duplicated, so that the storage tanker under normal weather conditions (not extreme conditions) will be able to maintain the position, also in situations where parts of the positioning equipment fail. Under weather conditions where the production platform is shut down and the crew is evacuated (storm condition), the tanker will disconnect and subsequently connect itself again when the weather conditions are normalised.

The invention will be further described below in connection with exemplary embodiments with reference to the drawings, wherein

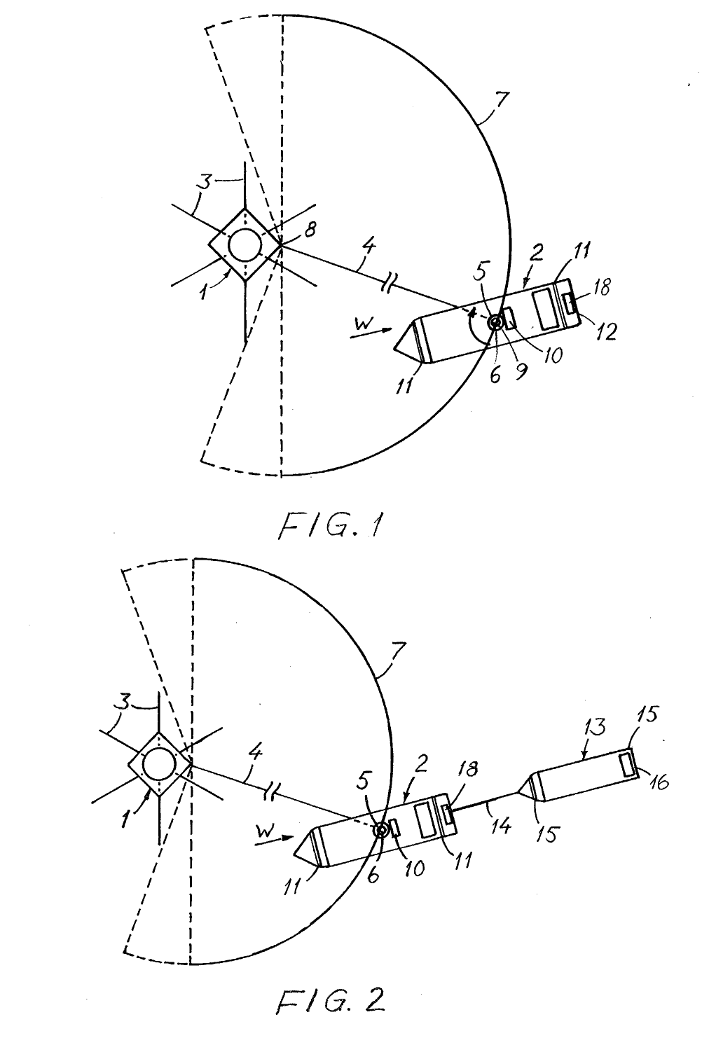

FIG. 1 shows a plan view of a platform and a tanker (FSO vessel) where the method according to the invention is applied;

FIG. 2 shows a plan view corresponding to FIG. 1, where a shuttle tanker for loading of oil is connected to the tanker;

FIG. 3 shows a side view of the elements in FIG. 2; and

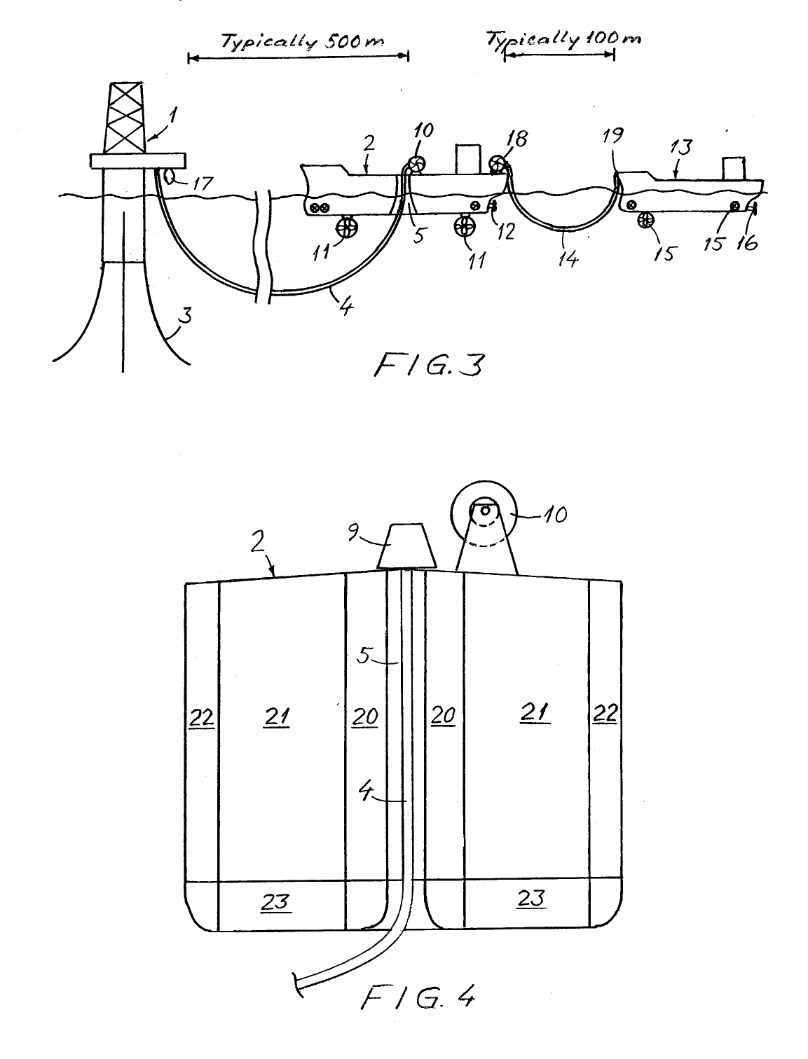

FIG. 4 shows a vertical cross-sectional view of the tanker in FIGS. 1-3, taken through a through-going shaft (moonpool) in the vessel.

In the different drawing figures similar or corresponding elements are designated by the same reference numerals.

FIG. 1 shows a plan view of an oil-producing platform 1 and a dynamically positioned (DP-operated) tanker 2 using the method according to the invention during an oil loading operation. The illustrated platform 1 is anchored to the sea bed with slack anchoring lines 3. As will be clear, the invention may also be used in connection with other types of platforms, such as tension leg platforms or platforms resting on the sea bed. The dynamically positioned or DP-operated tanker 2 is a so-called FSO vessel, where the abbreviation FSO stands for “Floating Storage and Off-loading”. The tanker 2 typically is located about 500 meters from the production platform 1. The oil produced on the platform is transferred to the tanker 2 via a flexible transfer or loading hose 4 (typical diameter 6-8″).

In the situation shown in FIG. 1, the system according to the invention is in the so-called “Receiving Mode”. In this mode the FSO vessel 2 will operate the DP system in what is called “Weathervane Mode”. This implies that the DP system of the tanker all the time will keep the tanker in the position wherein the power consumption is at a minimum. This implies that the tanker can turn freely 360° about a defined point, so that the tanker all the time has an optimal location with respect to power consumption. On the illustrated tanker, a vertically through-going shaft (moonpool) 5 is arranged in the centre of the tanker, approximately midships, and the turning point 6 will be at the centre of the shaft. The shaft and the turning centre may also be placed at other places on the tanker if this is desirable.

In order that the tanker shall not lie for longer periods with a heading directed towards the platform, and in order that it shall not drive or run into the production platform in an undesired accident, it must have the possibility to change the coordinates of the turning point 6, i.e. the centre of the shaft 5. An important feature of the present invention is that the DP system is programmed such that the tanker can move along a circular arc 7 which is predefined in relation to the platform, at the same time as it has the possibility to operate in the “weathervane mode”, i.e. rotate about the centre of the shaft 5, so that the bow of the ship faces the wind direction (designated W in the figure), without the bow pointing towards the platform, except in a transition phase.

It is essential that the tanker/FSO vessel all the time can move along the predefined circular arc in such a manner that one avoids that the heading of the tanker is directed towards the production platform. An exception from this will be short periods wherein the tanker is repositioned in case of big changes in the direction of the environmental forces.

The transfer or loading hose 4 extending between the platform and the tanker 2 typically is fastened to the platform at a corner 8 thereof. The suspension will be arranged such that it is possible to undertake an emergency disconnection which can be activated either from the platform or from the tanker. In order that the disconnected hose shall not come into conflict with possible anchoring lines, there may be provided e.g. an inflatable buoy seeing to it that the end piece of the hose does not sink in case of a disconnection. The hose is equipped with valves, so that oil spill is prevented in an emergency disconnection. The hose suitably may be introduced in the tanker through said shaft 5. As swivel system and a hanging device 9 will be arranged in the shaft. This arrangement may also be used for replacement of “wearing parts” of the hose. Under normal operating conditions the hose will be fastened here. In case of a disconnection on the production platform, the hose will be reeled in on a drum 10 placed on the deck of the tanker.

As shown in FIG. 1, the circular arc 7 has a limited extension, because of the fact that the loading hose 4 all the time will be fastened in a definite location on the platform 1. When the tanker 2 has moved to an outer limit of the circular arc (shown stippled in the figure), the tanker will be lying in the current position (or possibly move a distance backwards), and the tanker then will only have the possibility to turn about the turning point 6, to the desired heading.

The tanker 2 typically is kept in position by means of tunnel and/or azimuth thrusters 11 and by means of the main propeller 12 and rudder of the tanker. These will be arranged under the control of the DP computer of the tanker which will also be redundant.

In order that the FSO vessel shall maintain its position at any time, different reference systems will be adopted. A particular region of interest where the invention is intended to be applied, is the Gulf of Mexico. A reference system of the topical type will here typically be satellite-based or microwave-based. It is important to have several types of reference systems, so that one or more systems will always be in operation. The positioning may be relative or global.

FIGS. 2 and 3 show a plan view and a side view, respectively, of the arrangement in FIG. 1, but wherein a shuttle tanker 13 is connected to the tanker 2 via a loading hose 14 (typical diameter 16″), for the transfer or unloading of crude oil from the tanker to the shuttle tanker. The shuttle tanker 13 is shown to be situated astern of the tanker 2 in so-called tandem loading, and typically may be located about 100 meters from the tanker. The shuttle tanker typically may be a DP-operated tanker which maintains a constant distance to the tanker. This implies that the tanker must be equipped with reference systems so that the DP system of the shuttle tanker can keep a constant distance to the tanker. The shuttle tanker is shown to be provided with thrusters 15 (tunnel and/or azimuth) and a main propeller and rudder 16.

FIG. 3 shows how the loading hose 4 may be hung on the production platform 1, here shown together with an inflatable recovering buoy 17, as mentioned above. The figure also shows how the loading hose 4 and the unloading hose 14 can hang partly submerged in the sea, and how the loading hose 4 is introduced in the tanker 2 via the shaft 5.

At the stem of the tanker 2 there is shown to be arranged a drum 18 on which the unloading hose 14 is stored when the tanker is in the receiving mode mentioned above.

In the situation shown in FIGS. 2 and 3 the system according to the invention is in the so-called “Discharge Mode”. In this situation the tanker 2 has shifted from the DP operation in “Weathervane Mode” to DP-operation in so-called “Auto Position”. This implies that the DP system locks the tanker with respect to heading and in relation to the sea bed. This is the operating mode which typically will be used on the tanker when it is in the discharge or unloading mode. By means of the DP-system the tanker will all the time be able to control spare margins which are retained if wind, current or wave forces change direction after the unloading operation has started.

When the system is to work in the “Discharge Mode” and a shuttle tanker 13 is to be connected to the tanker 2, the shuttle tanker 13 will approach the tanker based on close contact with the captain of the tanker. When the shuttle tanker lies typically 50-100 meters astern of the tanker, a foreline is transferred from the tanker to the shuttle tanker. By means of the foreline the shuttle tanker winches stronger hawsers/wires over from the tanker, so that the shuttle tanker is enabled to pull over the unloading hose 14. After the unloading hose has come on board, this is connected to a bow coupling 19 on the shuttle tanker. The shuttle tanker is kept in position in relation to the tanker by means of its DP system which controls the admission or control signals to tunnel/azimuth thrusters, rudder and main propeller.

Normally, the shuttle tanker will lie on “Weathervane Mode” during the loading operation. If the external forces should change direction during the loading period, so that the angle between the tanker 2 (lying on the DP mode “Auto Position”) and the shuttle tanker becomes larger than what is agreed upon in the available procedures, the shuttle tanker has to ask the tanker to change heading, so that the angle again comes within the criteria settled in the procedures. Such changes of the heading of the tanker during a discharge or unloading period may also take place if other reasons should dictate this. Every such repositioning can only take place after a dialog between the responsible officers on the tanker and the shuttle tanker.

At the outset it is presupposed that there shall not be a hawser between the two tankers. However, this may be included if desired.

FIG. 4 shows a schematic cross-sectional view of the tanker 2. The section is taken through the shaft 5 of the tanker which is here presupposed to go through the centre of the tanker. The loading hose 4 is shown to be taken up through the shaft 5 which is flared at its lower end, to avoid unnecessary wear of the loading hose. During normal operations the loading hose is hung off in the aforementioned hanger device 9. The figure also shows the drum 10 on which the loading hose can be wound up if the tanker has to be disconnected. In the illustrated example the tanker further is shown to be equipped with a centre tank 20, wing tanks 21 and tanks 22 and 23 for ballast water in the sides and bottom of the vessel.

The method and the system according to the invention entail a number of substantial advantages which can be summarized as follows:

Deep-sea fields can be developed without being connected to pipeline systems

A dynamically positioned tanker can be used as a storage tanker (FSO tanker)

The tanker will always be able to be positioned so that it is situated downstream on the lee side of the production platform, except for short periods wherein the tanker is repositioned to the other side of the platform

The storage tanker can easily be connected and disconnected with minimum assistance from the platform

Generally little integration towards the production platform, since the equipment in all essentials is installed on the tanker

In a disconnection—emergency or planned—winding up and storage of the transfer hose will take place on the tanker

The tanker has full flexibility to rotate 360° about the centre of the shaft

The tanker may function as a storage under weather conditions up to maximum so-called “loop” current, i.e. large vertices which may be formed in the waters where the system is intended to be used, e.g. in the Gulf of Mexico.

1. A method of loading and storage of oil from a production platform on a tanker having a DP system for dynamic positioning, wherein the oil is transferred via a loading hose extending between the tanker and the platform, and wherein the tanker when required is moved substantially along a circular arc which is predefined relatively to the platform, at the same time as the tanker by means of the DP system when required is turned about a defined point on the tanker, for achieving an optimum power consumption during the loading operation.

2. A method according to claim 1, wherein the tanker is turned about a turning point which is located centrally in a shaft through the tanker.

3. A method according to claim 1 or 2, wherein said movements of the tanker are controlled by a suitably programmed computer.

4. A method according to claim 1 or 2, when unloading oil from the tanker to a shuttle tanker, wherein the tanker by means of the DP system is normally locked with respect to heading and in relation to the sea bed, the shuttle tanker being located in a tandem loading position astern of the tanker.

5. A system for loading and storage of oil from a production platform on a tanker which is equipped with a dynamic positioning system (DP system), the oil being transferred via a loading hose extending between the platform and the tanker, and wherein the propulsion system and the DP system of the tanker are arranged to be controlled such that the tanker when required is moved substantially along a circular arc which is predefined relatively to the platform, and so that the tanker when required is also turned about a defined point on the tanker, for achieving an optimum power consumption during the loading operation.

6. A system according to claim 5, wherein the tanker is equipped with a through-going shaft forming a centre for the turning movement.

7. A system according to claim 6, wherein the loading hose is connected to the tanker via said shaft.

8. A system according to any one of the claims 5-7, wherein the DP-system includes a computer which is programmed to control said movements of the tanker.

9. A system according to any one of the claims 5-7, when unloading oil from the tanker to a shuttle tanker, wherein the tanker is equipped with reference systems in order to enable the shuttle tanker to maintain a constant distance to the tanker, the shuttle tanker being located in a tandem loading position astern of the tanker.
